(19) United States
(12) Patent Application Publication
(10) Pub. No.: US 2025/0158852 A1
(43) Pub. Date: May 15, 2025

(54) APPARATUS AND METHOD FOR CHANNEL SOUNDING

(71) Applicant: Samsung Electronics Co., Ltd., Suwon-si (KR)

(72) Inventors: Eunsung Jeon, Suwon-si (KR); Myeongjin Kim, Suwon-si (KR); Jungwoon Lee, Suwon-si (KR)

(21) Appl. No.: 18/929,939

(22) Filed: Oct. 29, 2024

(30) Foreign Application Priority Data
Nov. 15, 2023 (KR) 10-2023-0158622

(51) Int. Cl. H04L 25/02; H04B 7/0417; H04B 17/336; H04W 84/12

(52) U.S. Cl. CPC H04L 25/0232; H04B 7/0417; H04B 17/336; H04L 25/0204; H04W 84/12

(57) ABSTRACT

An operating method of a first apparatus, communicating with a second apparatus in a wireless local area network (WLAN) system including the first apparatus and the second apparatus, includes receiving a null data packet (NDP) from the second apparatus, estimating channels corresponding to a plurality of streams of each of a plurality of subcarriers by using the NDP, decomposing singular values of the estimated channels to generate beam steering matrixes corresponding to the plurality of streams of each of the plurality of subcarriers, performing, by stream units, cross correlation between beam steering matrixes corresponding to an adjacent subcarrier of the plurality of subcarriers, determining interpolation target subcarriers, based on cross correlation values corresponding to the plurality of streams of each of the plurality of subcarriers, and generating beamforming feedback, based on the determined interpolation target subcarriers.

### CROSS-REFERENCE TO RELATED APPLICATION

This application is based on and claims priority under 35 U.S.C. § 119 to Korean Patent Application No. 10-2023-0158622, filed on Nov. 15, 2023, in the Korean Intellectual Property Office, the disclosure of which is incorporated by reference herein in its entirety.

### BACKGROUND

The inventive concept relates to wireless communication, and more particularly, to an apparatus and method for channel sounding based on a certain protocol standard.

As an example of wireless communication, wireless local area network (WLAN) may be technology which connects two or more apparatuses with each other by using a wireless signal transmission scheme, and WLAN technology may be based on the Institute of Electrical and Electronics Engineers (IEEE) 802.11 standard. The 802.11 standard has advanced to include 802.11b, 802.11a, 802.11g, 802.11n, 802.11ac, and 802.11ax and may support a transmission speed of 1 Gbyte/s, based on orthogonal frequency-division multiplexing (OFDM) technology.

In 802.11ac, data may be simultaneously transmitted to a number of users by using a multi-user multi-input multi-output (MU-MIMO) technique. Furthermore, in 802.11be, which is referred to as an extremely high throughput (EHT), and the next-generation protocol standard (hereinafter referred to as EHT+) succeeding EHT, it is desired to implement support for an unauthorized frequency band of 6 GHZ, the use of a band width of a maximum of 320 MHz per channel, the introduction of hybrid automatic repeat and request (HARQ), and support for a maximum of 16×16 MIMO.

Also, in a MU-MIMO communication environment, a beamforming process may be used to improve communication performance. In detail, a beamformer (or an access point) performing a beamforming process may perform beamforming based on feedback of a channel received from a beamformee (or a station). The beamformer may provide a beamformed signal to the beamformee. In a case where a channel smoothing operation is performed on the received signal, the beamformee, when there is discontinuity between beamforming matrixes corresponding to adjacent subcarriers of subcarriers of the signal, the loss of a discontinuous component may occur, and due to this, energy of the signal may decrease, causing an increase in packet error rate (PER). Therefore, the beamformee does not perform a separate channel smoothing operation on the beamformed signal.

### SUMMARY

The inventive concept provides an apparatus and method for channel sounding, which may reduce discontinuity between beamforming matrixes corresponding to adjacent subcarriers so that a beamformee performs a channel smoothing operation on a beamformed signal, in a wireless communication system.

According to an embodiment, an operating method of a first apparatus, communicating with a second apparatus in a wireless local area network (WLAN) system including the first apparatus and the second apparatus, includes receiving a null data packet (NDP) from the second apparatus, estimating channels corresponding to a plurality of streams of each of a plurality of subcarriers by using the NDP, decomposing singular values of the estimated channels to generate beam steering matrixes corresponding to the plurality of streams of each of the plurality of subcarriers, performing, by stream units, a cross correlation between beam steering matrixes corresponding to an adjacent subcarrier on the plurality of subcarriers, determining interpolation target subcarriers, based on cross correlation values corresponding to the plurality of streams of each of the plurality of subcarriers, and generating beamforming feedback, based on the determined interpolation target subcarriers.

According to an embodiment, a first apparatus, communicating with a second apparatus in a wireless local area network (WLAN) system, includes a channel estimator configured to estimate channels corresponding to a plurality of streams of each of a plurality of subcarriers by using a null data packet (NDP) received from the second apparatus, a discontinuity detector configured to perform, by stream units, a cross correlation between beam steering matrixes corresponding to an adjacent subcarrier on the plurality of subcarriers by using the estimated channels to determine interpolation target subcarriers where a representative cross correlation value is less than a threshold value and which are sequentially listed with respect to an index, and an interpolator configured to perform an interpolation operation to generate pieces of angle information about the determined interpolation target subcarriers.

According to an embodiment, an operating method of a first apparatus, communicating with a second apparatus in a wireless local area network (WLAN) system including the first apparatus and the second apparatus, includes receiving a null data packet (NDP) from the second apparatus, estimating channels corresponding to a plurality of streams of each of a plurality of subcarriers by using the NDP, performing, by stream units, a cross correlation between beam steering matrixes of adjacent subcarriers on the plurality of subcarriers by using the estimated channels, determining interpolation target subcarriers, where a representative cross correlation value is less than a threshold value and which are sequentially listed with respect to an index, of the plurality of subcarriers, performing an interpolation operation to generate pieces of angle information about the determined interpolation target subcarriers, and transmitting beamforming feedback, including the generated pieces of angle information, to the second apparatus.

### BRIEF DESCRIPTION OF THE DRAWINGS

Embodiments will be more clearly understood from the following detailed description taken in conjunction with the accompanying drawings in which:

FIG. 1 is a block diagram illustrating a wireless communication system, according to an example embodiment;

FIG. 2 is a diagram for describing discontinuity of a subcarrier-based beamforming matrix corresponding to a beamformed signal from an access point in a comparative example;

FIG. 3 is a block diagram illustrating a wireless communication system, according to an example embodiment;

FIG. 4 is a timing diagram illustrating channel sounding, according to an example embodiment;

FIG. 5 is a message diagram illustrating a method for channel sounding, according to an example embodiment;

FIG. 6 is a flowchart for describing an operating method of a beamformee, according to an example embodiment;

FIG. 7A is a flowchart for describing an operating method of a beamformee, according to an example embodiment, and FIG. 7B is a flowchart for describing operation S350 of FIG. 7A in detail;

FIG. 8 is a diagram for describing an operation of a beamformee, according to an example embodiment;

FIG. 9A is a flowchart for describing an operating method of a beamformee, according to an example embodiment, and FIG. 9B is a flowchart for describing operation S410 of FIG. 9A in detail;

FIGS. 10A and 10B are flowcharts for describing an operating method of a beamformee, according to an example embodiment;

FIG. 11A is a flowchart for describing an operating method of a beamformee, according to an example embodiment, and FIG. 11B is a table diagram for describing an example embodiment associated with operation S610 of FIG. 11A;

FIG. 12 is a flowchart for describing an operating method of a beamformee, according to an example embodiment;

FIG. 13 is a detailed block diagram of a beamformee, according to an example embodiment; and

FIG. 14 is a concept diagram illustrating an Internet of Things (IoT) network system to which example embodiments are applied.

### DETAILED DESCRIPTION OF THE EMBODIMENTS

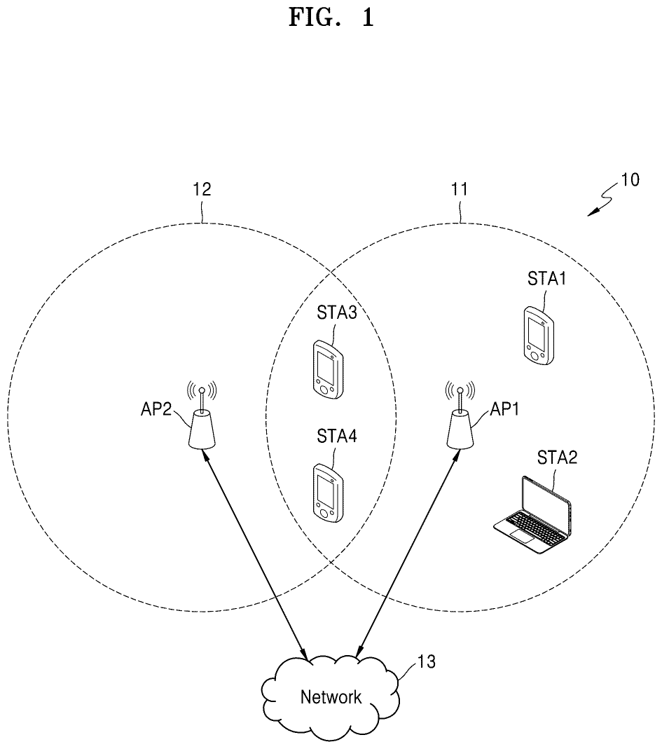

FIG. 1 is a block diagram illustrating a wireless communication system 10 according to an example embodiment. In detail, for example, FIG. 1 illustrates a wireless local area network (WLAN) system of the wireless communication system 10.

Hereinafter, in describing embodiments in detail, embodiments may be mainly based on an orthogonal frequency-division multiplexing (OFDM) or orthogonal frequency-division multiplexing access (OFDMA)-based wireless communication system (particularly, institute of electrical and electronics engineers (IEEE) 802.11 standard), and a main gist of an embodiment may be applied to the other communication systems (for example, a cellular communication system such as long term evolution (LTE), LTE-advanced (LTE-A), new radio (NR), wireless broadband (WiBro), or global system for mobile communication (GSM), or a close-distance communication system such as Bluetooth or near field communication (NFC)) having similar technical background and channel form through slight modification without largely departing from the scope of the inventive concept. This may be implemented by the those of ordinary skill in the art.

In various embodiments described below, a hardware access method may be described for example. However, various embodiments may include technology which uses all of hardware and software, and thus, various embodiments may not exclude a software-based access method.

Also, the terms used herein may be described for convenience of description, and it may be sufficiently understood that the technical spirits of the inventive concept is not limited thereto.

Referring to FIG. 1, the wireless communication system 10 may include first and second access points AP1 and AP2, a first station STA1, a second station STA2, a third station STA3, and a fourth station STA4. The first and second access points AP1 and AP2 may access a network 13 including Internet, Internet protocol (IP) network, or the other arbitrary network. The first access point AP1 may provide the first station STA1, the second station STA2, the third station STA3, and the fourth station STA4 with an access to the network 13 in a first coverage region 11, and moreover, the second access point AP2 may provide the third and fourth stations SAT3 and SAT4 with an access to the network 13 in a second coverage region 12. In some embodiments, the first and second access points AP1 and AP2 may communicate with at least one of the first station STA1, the second station STA2, the third station STA3, and the fourth station STA4, based on wireless fidelity (WiFi) or the other arbitrary WLAN access technology.

An access point may be referred to as a router or a gateway, and a station may be referred to as a mobile station, a subscriber station, a terminal, a mobile terminal, a wireless terminal, user equipment, or a user. A station may be a portable apparatus such as a mobile phone, a laptop computer, or a wearable apparatus, or may be a stationary apparatus such as a desktop computer or a smart television (TV). Herein, a station may be referred to as a first apparatus, and an access point may be referred to as a second apparatus.

The first and second access points AP1 and AP2 may allocate at least one resource unit (RU) to at least one of the first to fourth stations STA1 to STA4. The first and second access points AP1 and AP2 may transmit data through at least one allocated RU, and at least one of the first to fourth stations STA1 to STA4 may receive the data through at least one allocated RU. In 802.11ax, the first and second access points AP1 and AP2 may allocate only one RU to at least one of the first to fourth stations STA1 to STA4, and in 802.11be (hereinafter referred to as extremely high throughput (EHT)) or next-generation IEEE 802.11 standards (hereinafter referred to as EHT+), the first and second access points AP1 and AP2 may allocate a multi-resource unit (MRU) including two or more RUs to at least one of the first to fourth stations STA1 to STA4. For example, the first access point AP1 may allocate an MRU to at least one of the first station STA1, the second station STA2, the third station STA3, and the fourth station STA4 and may transmit data through the allocated MRU.

In an embodiment, the first and second access points AP1 and AP2 may communicate with at least one of the first to fourth stations STA1 to STA4 by using a beamforming technique. For example, single user beamforming may enhance the reception performance of a single user, and multi-user beamforming may remove interference between a number of users, and thus, may enhance the reception performance of the users. The first and second access points AP1 and AP2 and the first to fourth stations STA1 to STA4 may perform channel sounding for beamforming, and the channel sounding may be based on a sounding protocol. As described below with reference to the drawings, the first and second access points AP1 and AP2 may efficiently perform channel sounding with the first to fourth stations STA1 to STA4 which support various protocol standards (for example, EHT, EHT+, etc.). Hereinafter, a schematic embodiment of channel sounding between the first access point AP1 and the first station STA1 will be described. The technical spirit of channel sounding between the first access point AP1 and the first station STA1 may be applied to the second access point AP2 and the second to fourth stations STA2 to STA4.

The first access point AP1 may transmit a null data packet (NDP) based on a certain protocol standard to the first station STA1. Each of the first access point AP1 and the first station STA1 may include a plurality of antennas and may perform communication therebetween by using the plurality of antennas, based on multiple input multiple output (MIMO) technology. Therefore, the first access point AP1 may transmit the NDP through a plurality of paths by using a plurality of subcarriers, and the first station STA1 may receive the NDP as a plurality of streams through the plurality of paths. Herein, a stream may denote a signal received through an arbitrary path. As a detailed example, the plurality of paths may include a first path and a second path, and the first station STA1 may receive an NDP, transmitted through the first path, as a first stream and may receive an NDP, transmitted through the second path, as a second stream. Furthermore, a plurality of paths between the first access point AP1 and the first station STA1 may be determined based on the number of antennas used in communication of the first access point AP1 and the number of antennas used in communication of the first station STA1. Also, channels corresponding to one subcarrier may include channels corresponding to a plurality of streams.

The first station STA1 may estimate channels formed between the first access point AP1 and the first station STA1 by using the received NDP. In an embodiment, the first station STA1 may estimate channels corresponding to a plurality of streams of each of a plurality of subcarriers by using the received NDP. The first station STA1 may decompose the estimated channels into a singular value to generate beam steering matrixes corresponding to a plurality of streams of each of a plurality of subcarriers. The first station STA1 may perform, by stream units, a cross correlation between beam steering matrixes corresponding to an adjacent subcarrier on a plurality of subcarriers. The first station STA1 may determine interpolation target subcarriers, based on cross correlation values corresponding to a plurality of streams of each of a plurality of subcarriers. Herein, an interpolation target subcarrier may denote a subcarrier where angle information correlated with beamforming (for example, smooth beamforming) is generated by a certain interpolation operation because a channel correlation with an adjacent subcarrier is lower than a certain level. Also, a general subcarrier may denote a subcarrier where correlated angle information is directly generated because a channel correlation with an adjacent subcarrier is higher than or equal to a certain level. The first station STA1 may generate beamforming feedback including pieces of angle information about each of interpolation target subcarriers and general subcarriers and may transmit the beamforming feedback to the first access point AP1.

As described above, the first station STA1 may autonomously perform an interpolation operation to generate pieces of angle information about interpolation target subcarriers where a channel correlation with an adjacent subcarrier is lower than a certain level, and thus, may generate beamforming feedback suitable for performing beamforming in the first access point AP1.

The first access point AP1 and the first station STA1 may transmit and receive the beamforming feedback therebetween, and embodiments which perform beamforming based on the beamforming feedback may be defined based on a certain protocol standard. For example, the certain protocol standard may be an EHT protocol standard or an EHT+protocol standard.

The first to fourth stations STA1 to STA4 according to an embodiment may determine interpolation target subcarriers of a plurality of subcarriers to optimize beamforming of the first and second access points AP1 and AP2, generate pieces of angle information about the determined interpolation target subcarriers through a certain interpolation operation, and provide the angle information to the first and second access points AP1 and AP2.

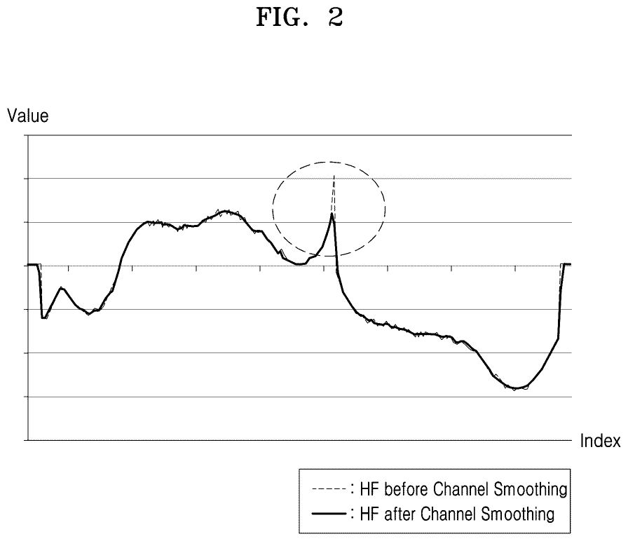

FIG. 2 is a diagram for describing a discontinuity of a subcarrier-based beamforming matrix corresponding to a beamformed signal from an access point in a comparative example.

Referring to FIG. 2, in the comparative example, an access point may perform beamforming on a station, based on beamforming feedback received from the station. In this case, the beamforming performed by the access point may be smooth beamforming. Also, as illustrated by a dotted line, discontinuity between beamforming matrixes HF corresponding to arbitrary adjacent subcarriers may occur due to the smooth beamforming. When the station performs channel smoothing on the beamforming matrixes HF having discontinuity, large energy loss may occur as illustrated in FIG. 2. To prevent such a problem, the station may determine, as interpolation target subcarriers, subcarriers causing discontinuity between the beamforming matrixes HF, generate pieces of angle information about the interpolation target subcarriers through a certain interpolation operation, add the angle information to beamforming feedback, and provide the beamforming feedback including the angle information to the access point.

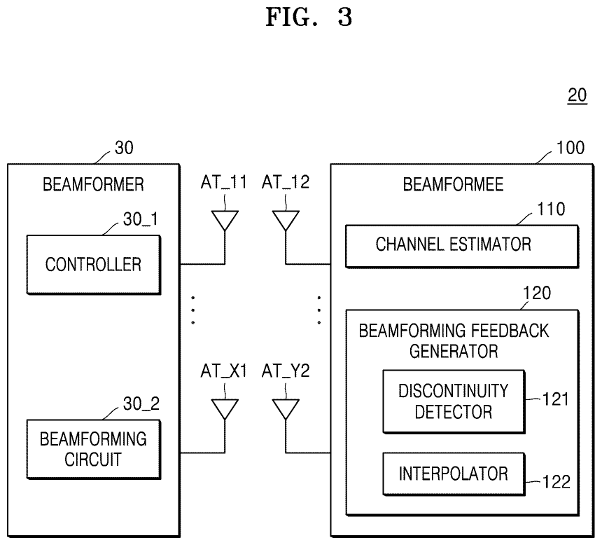

FIG. 3 is a block diagram illustrating a wireless communication system 20 according to an example embodiment. In FIG. 3, a beamformer 30 and a beamformee 100 communicating with each other in the wireless communication system 20 are illustrated. Each of the beamformer 30 and the beamformee 100 may be an arbitrary apparatus performing communication in the wireless communication system 20 and may be referred to as an apparatus for wireless communication. In some embodiments, each of the beamformer 30 and the beamformee 100 may be an access point (e.g., first and second access points AP1 and AP2 of FIG. 1) or a station (e.g., first to fourth stations STA1 to STA4 of FIG. 1) of a WLAN system.

Referring to FIG. 3, the beamformer 30 may include a controller 30_1, a beamforming circuit 30_2, and a plurality of first antennas AT_11 to AT_X1. In some embodiments, the controller 30_1 and the beamforming circuit 30_2 may be defined as a processing circuit of the beamformer 30. The beamformee 100 may include a channel estimator 110, a beamforming feedback generator 120, and a plurality of second antennas AT_12 to AT_Y2. In some embodiments, the channel estimator 110 and the beamforming feedback generator 120 may be defined as a processing circuit of the beamformee 100. Hereinafter, the beamformee 100 will be first described.

The beamformee 100 may receive an NDP through the plurality of second antennas AT_12 to AT_Y2 from the beamformer 30. The channel estimator 110 may estimate channels corresponding to a plurality of subcarriers by using a reference signal included in the received NDP. In some embodiments, an NDP may be referred to as a sounding packet. The NDP “yₖ” received for channel estimation by the channel estimator 110 may be expressed as in the following Equation 1.

$${y}_{k} = {H}_{k} {x}_{k} + {n}_{k} \qquad [ Equation 1 ]$$

In Equation 1, Hₖ may be a channel matrix of a subcarrier, xₖ may be a transmission data signal, and nₖ may represent thermal noise. Also, k may be represent a subcarrier index and may have a range of 1 to N_{FFT}. A size of the channel matrix “Hₖ” may be “Nr×Nt”. Here, Nr may denote an index associated with the number of second antennas AT_12 to AT_Y2, and Nt may denote an index associated with the number of first antennas AT_11 to AT_X1. Each factor of Equation 1 may be defined as a matrix or a vector. For example, the transmission data signal “Xₖ” may have a size of Nt×1. The thermal noise “nₖ” may denote white Gaussian noise. The thermal noise “nₖ” may have a size of Nr×1.

The channel estimator 110 may generate channel state information, based on the estimated channels. The channel state information may include at least one of a channel quality indicator (CQI), a precoding matrix indicator (PMI), and a rank indicator (RI).

The beamforming feedback generator 120 may decompose singular values of the channels “Ĥ_{est,k}” estimated by the channel estimator 110 as in Equation 2.

$${\hat{H}}_{est , k} = {U}_{k} {Σ}_{k} {V}_{k}^{h} \qquad [ Equation 2 ]$$

In Equation 2, Uₖ may be a left singular matrix, and Vₖ may be a right singular matrix and may include a Hermitian operator. Also, Σₖ may be a diagonal matrix including singular values which are not negative.

A size of the left singular matrix “Uₖ” may be “Nt×Nc”. Here, Nc may denote an index associated with the number of streams (or the number of layers) or the number of first antennas AT_11 to AT_X1. A size of the right singular matrix “Vₖ” may be “Nr×Nc”. Also, a size of Σₖ may be “Nc×Nc”. The right singular matrix “Vₖ” may be referred to as a beam steering matrix. In the wireless communication system 20 (for example, an IEEE 802.11n/ac/ax WLAN system), because the beamformer 30 transmits a signal to the beamformee 100 through orthogonal frequency division multiplexing (OFDM) modulation where the orthogonality of NFFT number of subcarriers in one symbol is guaranteed, a channel estimation operation of the channel estimator 110 and a singular value decomposition operation of the beamforming feedback generator 120 may be performed on a plurality of streams for each subcarrier.

In an embodiment, the beamforming feedback generator 120 may include a discontinuity detector 121. The discontinuity detector 121 may calculate a channel correlation with an adjacent subcarrier of a plurality of subcarriers by using beam steering matrixes “Vₖ” corresponding to the plurality of streams of each of a plurality of subcarriers.

For example, the discontinuity detector 121 may perform, by stream units, a cross correlation of beam steering matrixes corresponding to an adjacent subcarrier on a plurality of subcarriers, based on Equation 3.

$$ρ ( i , k ) = \frac{Re \{ {V}_{i}^{*} [ k - 1 ] {V}_{i} [ k ] \}}{\vert {V}_{i}^{*} [ k - 1 ] {V}_{i} [ k ] \vert} \qquad [ Equation 3 ]$$

In Equation 3, i [symbol] may denote a stream index, k may denote a subcarrier index, V may denote a beam steering matrix, and V* may denote a conjugate transpose matrix of V which is a beam steering matrix. Also, ρ(i, k) may correspond to a cross correlation value between a beam steering matrix “Vᵢ[k]” corresponding to a stream having a stream index of i of a subcarrier having a subcarrier index of k and a beam steering matrix “Vᵢ[k−1]” corresponding to a stream having a stream index of i of an adjacent subcarrier having a subcarrier index of k−1. In detail, ρ(i, k) may be calculated by dividing a real number value of a correlation value between the beam steering matrixes “Vᵢ[k]” and “Vᵢ[k−1]” by an absolute value of a correlation value of the beam steering matrixes “Vᵢ[k]” and “Vᵢ[k−1]”. For example, ρ(i, k) may have a range of a value [−1, 1] and may denote that a correlation between beam steering matrixes of two adjacent subcarriers decreases as a value is reduced. Herein, a subcarrier having a subcarrier index of k may be referred to as a (k)^{th} subcarrier, and a stream having a stream index of i [symbol] may be referred to as an (i)^{th} stream.

In an embodiment, the discontinuity detector 121 may determine interpolation target subcarriers of a plurality of subcarriers, based on cross correlation values corresponding to a plurality of streams of each of the plurality of subcarriers.

For example, the discontinuity detector 121 may determine a start subcarrier and an end subcarrier, based on Equation 4, and may determine interpolation target subcarriers, based on the determined start subcarrier and end subcarrier.

$${k}_{start} = {arg}_{k} [ {ρ}_{min} ( k ) ] < T \qquad [ Equation 4 ]$$

$${k}_{end} = {arg}_{k} [ {ρ}_{min} ( k ) ] \geq T$$

$${ρ}_{min} ( k ) = {min}_{i} [ ρ ( i , k ) ] , i = 0 , 1 , … , Nc$$

In Equation 4, Nc may denote the number of streams, and ρₘᵢₙ(k) may denote a minimum value of cross correlation values corresponding to a plurality of streams of a (k)^{th} subcarrier and may be referred to as a representative cross correlation value of a (k)^{th} subcarrier. The discontinuity detector 121 may apply Equation 4 up to a subcarrier having a highest index from a subcarrier having a lowest index (for example, k=1). Also, T may denote a threshold value, and kₛₜₐᵣₜ may denote an index of a start subcarrier, first having a representative cross correlation value which is less than the threshold value, of a plurality of subcarriers listed in an index order. Also, k_{end} may denote an index of an end subcarrier, first having a representative cross correlation value which is greater than or equal to the threshold value, of subcarriers listed subsequent to the start subcarrier. The discontinuity detector 121 may determine, as interpolation target subcarriers, subcarriers having indexes between kₛₜₐᵣₜ and k_{end}. In some embodiments, the discontinuity detector 121 may determine a plurality of start subcarriers and a plurality of end subcarriers among a plurality of subcarriers, and based thereon, the discontinuity detector 121 may determine interpolation target subcarriers included in each of groups apart from one another with respect to an index.

Furthermore, the beamforming feedback generator 120 may generate pieces of angle information “ϕ, ψ” suitable for beam steering matrixes so as to reduce an overhead of beamforming feedback transmitted to the beamformer 30, based on Equations 5 to 8.

$${Q}_{k} = {V}_{k} D \qquad [ Equation 5 ]$$

In Equation 5, Qₖ may denote a latter beam steering matrix, and a first diagonal matrix “D” may be a matrix for allowing an element of a last row of each column of the latter beam steering matrix “Qₖ” to have a real number value. For example, the first diagonal matrix “D” may be (e^{-jϕ(Nt,1)}, . . . , e^{-jϕ(Nt,Nr)}, and for example, e^{-jϕ(Nt,1)} may denote a phase value of an element corresponding to an (Nt)^{th} row and a first column of the beam steering matrix “Vₖ”. In some embodiments, the first diagonal matrix “D” may include a phase value of an element of a last row of each column of the beam steering matrix “Vₖ”.

$${Q}_{k} = [ {\prod }_{i = 1}^{min ( {N}_{r} , {N}_{t} - 1 )} [ {D}_{i} ( {1}_{i - 1} , {e}^{j {ϕ}_{i , i}} , … , {e}^{j {ϕ}_{Nr - {1}_{, i}}} , 1 ) {\prod }_{l = i + 1}^{{N}_{t}} {G}_{li}^{T} ( {ψ}_{li} ) ] ] {\check{I}}_{Nt \times Nr} \qquad [ Equation 6 ]$$

In Equation 6, 1ᵢ₋₁ may denote a vector where a length consists of 1 which is “i−1”. Also, I_{Nt×Nr} may denote an identity matrix having a size of Nt×Nr.

In Equation 6,

$${D}_{i} ( {1}_{i - 1} , {e}^{j {ϕ}_{i , i}} , … , {e}^{j {ϕ}_{{N}_{r - 1} , i}} , 1 )$$

may be represented as a second diagonal matrix as in the following Equation 7.

$${D}_{i} ( {1}_{i - 1} , {e}^{j {ϕ}_{i , i}} , … , {e}^{j {ϕ}_{N r - 1 , i}} , 1 ) = [ \begin{matrix}{I}_{i - 1} & 0 & … & … & 0 \\ 0 & {e}^{j {ϕ}_{i , i}} & 0 & … & 0 \\ ⋮ & 0 & ⋱ & 0 & 0 \\ ⋮ & ⋮ & 0 & {e}^{j {ϕ}_{{N}_{t - 1} , i}} & 0 \\ 0 & 0 & 0 & 0 & 1\end{matrix} ] , \qquad [ Equation 7 ]$$

In Equation 7, G_{li(ψ)} may be represented as a givens rotation matrix as in the following Equation 8.

$${G}_{li} ( ψ ) = [ \begin{matrix}{I}_{i - 1} & 0 & 0 & … & 0 \\ 0 & cos ( ψ ) & 0 & sin ( ψ ) & 0 \\ 0 & 0 & {I}_{l - i - 1} & 0 & 0 \\ 0 & - sin ( ψ ) & 0 & cos ( ψ ) & 0 \\ 0 & 0 & 0 & 0 & {I}_{Nt - 1}\end{matrix} ] \qquad [ Equation 8 ]$$

That is, the beamforming feedback generator 120 may generate pieces of angle information “ϕ, ψ” representing sizes and phases of beam steering matrixes “Vₖ” of a plurality of subcarriers, based on Equations 5 to 8. Also, ϕ may represent a phase of a beam steering matrix “Vₖ”, and ψ may represent a size of a beam steering matrix “Vₖ”.

In an embodiment, the beamforming feedback generator 120 may include an interpolator 122. The interpolator 122 may perform a certain interpolation operation to generate pieces of angle information corresponding to the interpolation target subcarriers determined by the discontinuity detector 121. For example, the interpolator 122 may perform an interpolation operation based on angle information about a start subcarrier and angle information about an end subcarrier corresponding to each of the interpolation target subcarriers to generate angle information corresponding to the interpolation target subcarriers. Herein, angle information about a start subcarrier may be referred to as start angle information, and angle information about an end subcarrier may be referred to as end angle information.

As a detailed example, the interpolator 122 may generate pieces of angle information “ϕₖ” and “ψₖ” about the interpolation target subcarriers, based on the following Equation 9.

$${ϕ}_{k} = \frac{k - {k}_{start}}{{k}_{end} - {k}_{start}} ( mod ( ( {ϕ}_{{k}_{end}} - {ϕ}_{{k}_{start}} ) + π , 2 π ) - π ) + {ϕ}_{{k}_{start}} \qquad [ Equation 9 ]$$

$${ψ}_{k} = \frac{k - {k}_{start}}{{k}_{end} - {k}_{start}} ( {ψ}_{{k}_{end}} - {ψ}_{{k}_{start}} ) + {ψ}_{{k}_{start}}$$

$$P = \{ {k}_{1} , {k}_{2} , … , {k}_{M} \} , {k}_{start} < {k}_{1} , {k}_{M} < {k}_{end}$$

In Equation 9, P may be a set of indexes of the interpolation target subcarriers, ϕₖ may be phase information about an interpolation target subcarrier having an index of k among the interpolation target subcarriers, and ψₖ may be size information about an interpolation target subcarrier having an index of k among the interpolation target subcarriers. Also, k₁ may be a smallest index of indexes included in P [symbol] , and k_{M} may be a largest index of indexes included in P. Also, ϕₖ_{ₛₜₐᵣₜ} may be phase information about a start subcarrier corresponding to the interpolation target subcarriers, and ψₖ_{ₛₜₐᵣₜ} may be size information about the start subcarrier corresponding to the interpolation target subcarriers. Also, ϕₖ_{_{end}} may be phase information about an end subcarrier corresponding to the interpolation target subcarriers, and ψₖ_{_{end}} may be size information about the end subcarrier corresponding to the interpolation target subcarriers.

The beamforming feedback generator 120 may generate pieces of angle information “ϕ, ψ” about general subcarriers other than the interpolation target subcarriers, based on Equations 5 to 8 described above. In some embodiments, the beamforming feedback generator 120 may preferentially generate start angle information about a start subcarrier and end angle information about an end subcarrier corresponding to interpolation target subcarriers of the general subcarriers. An operation of generating pieces of angle information corresponding to the general subcarriers by using the beamforming feedback generator 120 may be performed in parallel with an interpolation operation of generating pieces of angle information corresponding to the interpolation target subcarriers by using the interpolator 122.

In an embodiment, the beamforming feedback generator 120 may quantize pieces of angle information corresponding to a plurality of subcarriers to generate beamforming feedback including pieces of quantized angle information. The beamformee 100 may transmit the beamforming feedback to the beamformer 30 through a transceiver of the beamformee 100 and the plurality second antennas AT_12 to AT_Y2.

The beamformer 30 may receive the beamforming feedback from the beamformee 100 through the transceiver (not shown) and the plurality of first antennas AT_11 to AT_X1. The controller 30_1 may control an overall operation for communication of the beamformer 30. The controller 30_1 may generate a null data packet announcement (NDPA) frame and an NDP each described below and may perform control so that the beamforming circuit 30_2 uses information included in the beamforming feedback.

The beamforming circuit 30_2 according to an embodiment may perform smooth beamforming on the beamformee 100, based on the beamforming feedback. Beamforming performance may denote an operation of determining a beamforming matrix for each subcarrier of a signal transmitted from the beamformer 20 to the beamformee 100. The beamforming circuit 30_2 may perform a beamforming operation based on pieces of angle information about beamforming feedback.

To sum up, in the comparative example of FIG. 2, the discontinuity of the beamforming matrixes HF may be caused by pieces of angle information corresponding to a plurality of subcarriers that are mechanically processed and provided to the beamformer 30 without differentiating interpolation target subcarriers in the beamformee 100, and to prevent such a problem, the beamformee 100 may selectively perform an interpolation operation on interpolation target subcarriers, where a channel correlation with an adjacent subcarrier is lower than a certain level, to generate pieces of angle information and may provide the angle information to the beamformer 30, thereby decreasing the discontinuity of the beamforming matrixes HF.

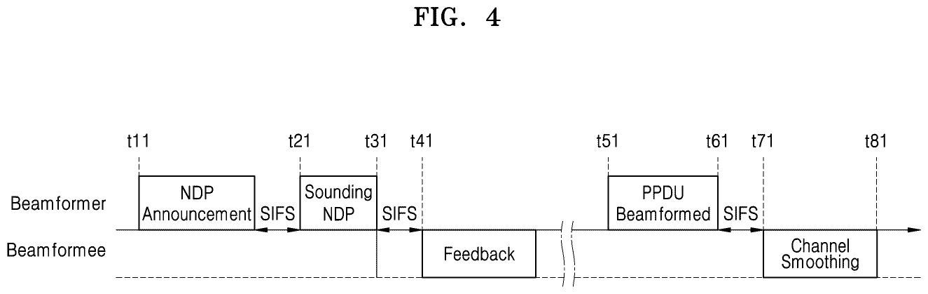

FIG. 4 is a timing diagram illustrating channel sounding according to an example embodiment. In detail, the timing diagram of FIG. 4 may show channel sounding performed by a beamformer and a beamformee. The channel sounding may be performed based on various protocol standards. In some embodiments, the beamformer may be an access point (or a second apparatus), and the beamformee may be a station (or a first apparatus). For example, the beamformer may be one of the first and second access points AP1 and AP2 of FIG. 1, and the beamformee may be one of the first to fourth stations STA1 to STA4 of FIG. 1. However, this may be merely an embodiment, and thus, it may be noted that embodiments are not limited to the channel sounding of FIG. 4.

Referring to FIG. 4, at a time t11, the beamformer may transmit an NDPA frame to the beamformee. For example, the beamformer may transmit the NDPA frame, indicating transmission of a sounding NDP, to the beamformee so as to obtain channel state information about a downlink. The NDPA frame may be a control frame, and the beamformee may prepare for the reception of the sound NDP, based on the NDPA frame.

At a time t21, the beamformer may transmit the sounding NDP (or the NDP) to the beamformee. For example, the beamformer may transmit the NDPA frame to the beamformee, and then, after a short interframe space (SIFS) time, the beamformer may transmit the sounding NDP to the beamformee. The beamformer may transmit the sounding NDP to the beamformee through a plurality of paths formed by using a plurality of first antennas, and the beamformee may estimate channels corresponding to a plurality of streams of a plurality of subcarriers, based on the sounding NDP received through the plurality of paths. In an embodiment, the beamformee may determine interpolation target subcarriers, where a channel correlation with an adjacent subcarrier is lower than a certain level, of the plurality of subcarriers and may perform an interpolation operation to indirectly generate pieces of angle information corresponding to the interpolation target subcarriers. The beamformee may consider all of the plurality of streams in determining the interpolation target subcarriers, and thus, may provide beamforming feedback suitable for the beamformer supporting MIMO technology. The beamformee may generate beamforming feedback which includes the pieces of angle information corresponding to the interpolation target subcarriers and pieces of angle information corresponding to general subcarriers.

At a time t41, the beamformee may transmit the beamforming feedback to the beamformer. For example, the beamformee may transmit beamforming feedback, including pieces of angle information needed for smooth beamforming, to the beamformer after an SIFS time from a time t31 which is a time after the sound NDP is received.

At a time t51, the beamformer may perform smooth beamforming to determine beamforming matrixes, based on pieces of angle information about subcarriers, and may transmit a smooth beamformed physical protocol data unit (PPDU) to the beamformee, based on the determined beamforming matrixes.

The beamformee may perform channel smoothing on the smooth beamformed PPDU up to a time t81 from a time t71 which is a time after the SIFS time from a time t61, and then, may process the smooth beamformed PPDU.

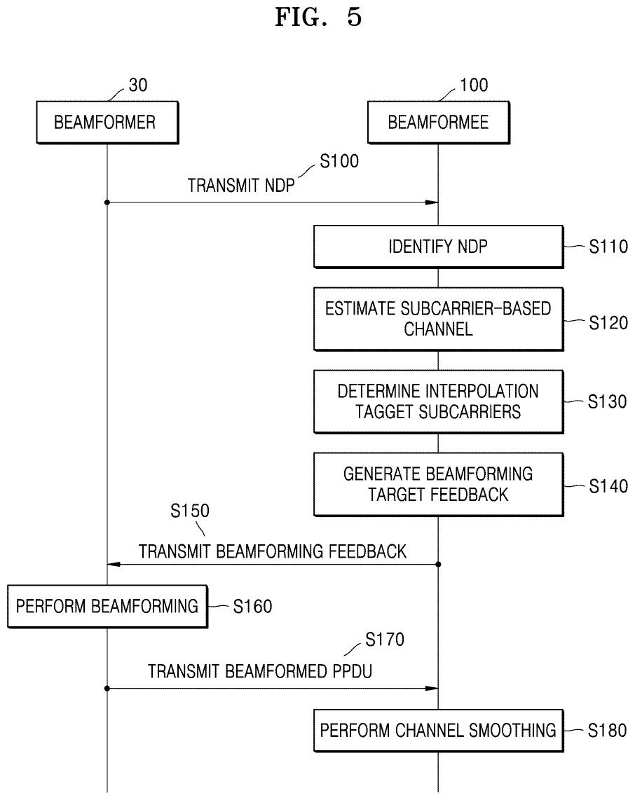

FIG. 5 is a message diagram illustrating a method for channel sounding, according to an example embodiment. In detail, the message diagram of FIG. 5 may show operations of a beamformer 30 which is an access point (e.g., first and second access points AP1 and AP2 of FIG. 1) and a beamformee 100 which is one of a plurality of stations (e.g., first to fourth stations STA1 to STA4 of FIG. 1), over time.

Referring to FIG. 5, at operation S100, the beamformer 30 may transmit an NDP to the beamformee 100.

At operation S110, the beamformee 100 may identify the NDP. For example, the beamformee 100 may extract pieces of information (or pieces of data) included in fields of the NDP transmitted thereto from the beamformer 30.

At operation S120, the beamformee 100 may perform subcarrier-based channel estimation by using the pieces of information extracted from the fields of the NDP. For example, the beamformee 100 may estimate channels corresponding to streams of each of subcarriers and may decompose singular values of the estimated channels to generate beam steering matrixes corresponding to the streams of each subcarrier.

At operation S130, the beamformee 100 may determine interpolation target subcarriers of the subcarriers. For example, the beamformee 100 may perform, by stream units, a cross correlation between the beam steering matrixes corresponding to an adjacent subcarrier on the subcarriers and may determine the interpolation target subcarriers, based on cross correlation values corresponding to the streams of each subcarrier. In detail, the beamformee 100 may extract, as a representative cross correlation value, a minimum value of the cross correlation values corresponding to the streams of each subcarrier and may sequentially compare a threshold value with representative cross correlation values of the subcarriers with respect to an index to detect a start subcarrier and an end subcarrier for determining the interpolation target subcarriers. Subsequently, the beamformee 100 may determine, as the interpolation target subcarriers, subcarriers between the start subcarrier and the end subcarrier with respect to the index.

At operation S140, the beamformee 100 may generate beamforming feedback including pieces of angle information associated with the estimated channels corresponding to the subcarriers. For example, the beamformee 100 may directly perform an arithmetic operation to generate pieces of angle information from beam steering matrixes corresponding to general subcarriers and may perform a certain interpolation operation to indirectly generate pieces of angle information corresponding to the interpolation target subcarriers. In detail, the beamformee 100 may perform an interpolation operation to generate pieces of angle information about the interpolation target subcarriers, based on pieces of angle information about a start subcarrier and an end subcarrier which are included in the general subcarriers and correspond to the interpolation target subcarriers.

At operation S150, the beamformee 100 may transmit the beamforming feedback to the beamformer 30. For example, the beamforming feedback may include a field including a subfield where pieces of angle information about subcarriers are provided.

At operation S160, the beamformer 30 may perform smooth beamforming, based on the beamforming feedback. For example, the beamformer 30 may determine subcarrier-based beamforming matrixes, based on the pieces of angle information about the subcarriers of the beamforming feedback.

At operation S170, the beamformer 30 may transmit a beamformed PPDU to the beamformee 100, based on the subcarrier-based beamforming matrixes which are determined at operation S160.

At operation S180, the beamformee 100 may perform channel smoothing on beamforming matrixes corresponding to a beamformed PPDU. Subsequently, the beamformee 100 may process the beamformed PPDU.

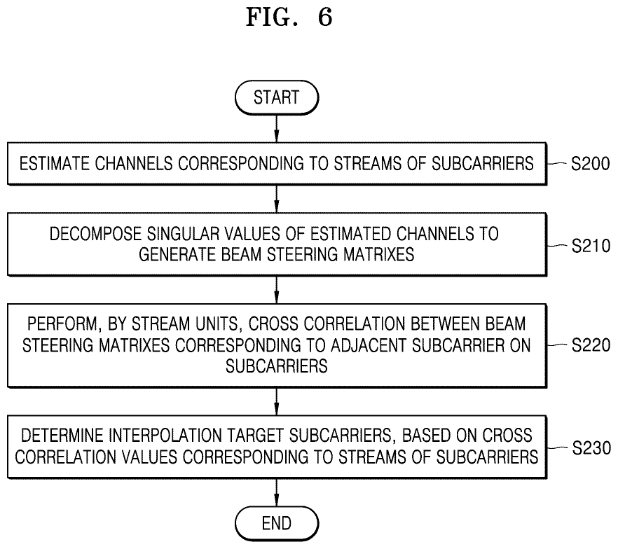

FIG. 6 is a flowchart for describing an operating method of a beamformee, according to an example embodiment. FIG. 6 may describe a method of determining interpolation target subcarriers by using a beamformee.

Referring to FIG. 6, at operation S200, the beamformee may estimate channels corresponding to streams of subcarriers. For example, the beamformee may receive an NDP from a beamformer through a plurality of paths and may estimate channels corresponding to streams suitable for the plurality of paths for each subcarrier, based on the NDP.

At operation S210, the beamformee may decompose singular values of the channels, which are estimated at operation S200, to generate beam steering matrixes corresponding to the streams of the subcarriers.

At operation S220, the beamformee may perform, by stream units, a cross correlation between the beam steering matrixes corresponding to an adjacent subcarrier on the subcarriers. For example, when the subcarriers include first and second subcarriers adjacent to each other and the streams include first and second streams, the beamformee may perform a cross correlation between a beam steering matrix corresponding to a first stream of the first subcarrier and a beam steering matrix corresponding to a first stream of the second subcarrier and may perform a cross correlation between a beam steering matrix corresponding to a second stream of the first subcarrier and a beam steering matrix corresponding to a second stream of the second subcarrier.

At operation S230, the beamformee may determine interpolation target subcarriers, based on cross correlation values corresponding to the streams of the subcarriers. For example, the beamformee may extract representative cross correlation values of the subcarriers among the cross correlation values and may sequentially compare a threshold value with the representative cross correlation values of the subcarriers with respect to an index to determine a start subcarrier and an end subcarrier. The beamformee may determine the interpolation target subcarriers, based on the determined start subcarrier and end subcarrier.

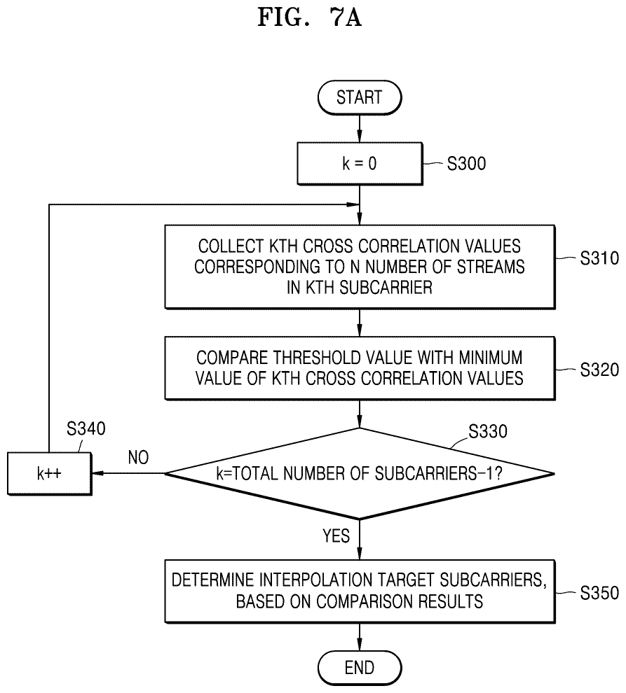

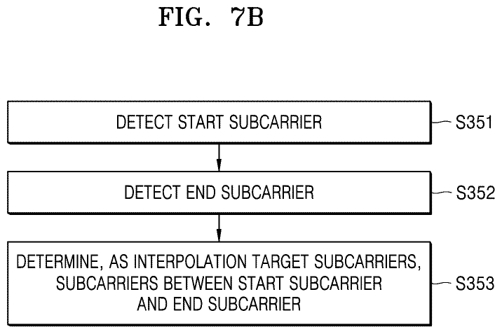

FIG. 7A is a flowchart for describing an operating method of a beamformee, according to an example embodiment, and FIG. 7B is a flowchart for describing operation S350 of FIG. 7A in detail.

Referring to FIG. 7A, at operation S300, the beamformee may set k to 0 and may start an operation of determining interpolation target subcarriers.

At operation S310, the beamformee may collect kth cross correlation values corresponding to n number streams in a kth subcarrier. For example, the beamformee may perform a cross correlation between beam steering matrixes corresponding to an adjacent subcarrier on the n streams for all subcarriers to generate cross correlation values and may extract kth cross correlation values from among the generated cross correlation values.

At operation S320, the beamformee may compare the threshold value with a minimum value of the kth cross correlation values. The minimum value of the kth cross correlation values may be referred to as a representative cross correlation value.

At operation S330, the beamformee may determine whether k is equal to a value obtained by subtracting 1 from the total number of subcarriers.

When operation S330 is ‘NO’, the beamformee may count up k at operation S340 and may repeat subsequent operations including operations S310.

When operation S330 is ‘YES’, at operation S350, the beamformee may determine interpolation target subcarriers, based on comparison results.

Referring further to FIG. 7B, at operation S351, the beamformee may detect a start subcarrier first having a representative cross correlation value, which is less than the threshold value, from among subcarriers listed in an index order.

At operation S352, the beamformee may detect an end subcarrier first having a representative cross correlation value, which is greater than or equal to the threshold value, from among subcarriers subsequent to the detected start subcarrier.

At operation S353, the beamformee may determine, as interpolation target subcarriers, subcarriers between the start subcarrier detected at operation S351 and the end subcarrier detected at operation S352.

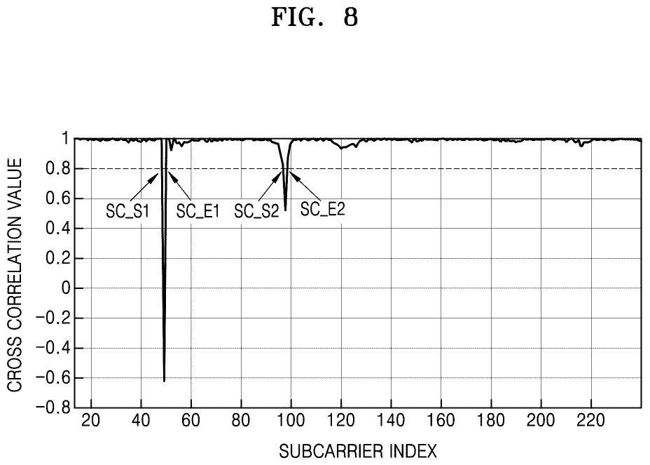

FIG. 8 is a diagram for describing an operation of a beamformee, according to an example embodiment.

Referring to FIG. 8, the beamformee may determine first interpolation target subcarriers and second interpolation target subcarriers from among a plurality of subcarriers which have indexes of 0 to 220 and are listed in an index order.

In an embodiment, the beamformee may sequentially compare a threshold value (for example, 0.8) with representative cross correlation values of a plurality of subcarriers with respect to an index and may determine the first interpolation target subcarriers and the second interpolation target subcarriers, based on a comparison result.

In an embodiment, the beamformee may detect a first start subcarrier SC_S1 first having a representative cross correlation value, which is less than the threshold value, from among a plurality of subcarriers having an index of 40 to 60 and may detect a first end subcarrier SC_E1 first having a representative cross correlation value, which is greater than or equal to the threshold value, after the first start subcarrier SC_S1. The beamformee may determine, as the first interpolation target subcarriers, subcarriers listed between the first start subcarrier SC_S1 and the first end subcarrier SC_E1.

In an embodiment, the beamformee may detect a second start subcarrier SC_S2 first having a representative cross correlation value, which is less than the threshold value, from among a plurality of subcarriers having an index of 80 to 120 and may detect a second end subcarrier SC_E2 first having a representative cross correlation value, which is greater than or equal to the threshold value, after the second start subcarrier SC_S2. The beamformee may determine, as the second interpolation target subcarriers, subcarriers listed between the second start subcarrier SC_S2 and the second end subcarrier SC_E2. A first group including the first interpolation target subcarriers may be apart from a second group including the second interpolation target subcarriers with respect to an index.

In an embodiment, the beamformee may perform an interpolation operation to generate pieces of angle information corresponding to the first interpolation target subcarriers, based on pieces of angle information about the first start subcarrier SC_S1 and the first end subcarrier SC_E1 corresponding to the first interpolation target subcarriers.

In an embodiment, the beamformee may perform an interpolation operation to generate pieces of angle information corresponding to the second interpolation target subcarriers, based on pieces of angle information about the second start subcarrier SC_S2 and the second end subcarrier SC_E2 corresponding to the second interpolation target subcarriers.

In an embodiment, the beamformee may independently perform an interpolation operation of generating the pieces of angle information corresponding to the first interpolation target subcarriers and an interpolation operation of generating the pieces of angle information corresponding to the second interpolation target subcarriers. In an embodiment, the beamformee may perform, in conjunction with each other, the interpolation operation of generating the pieces of angle information corresponding to the first interpolation target subcarriers and the interpolation operation of generating the pieces of angle information corresponding to the second interpolation target subcarriers.

However, FIG. 8 may be merely an example embodiment, and the beamformee may determine interpolation target subcarriers included in more groups or fewer groups, based on a channel state and the number of streams.

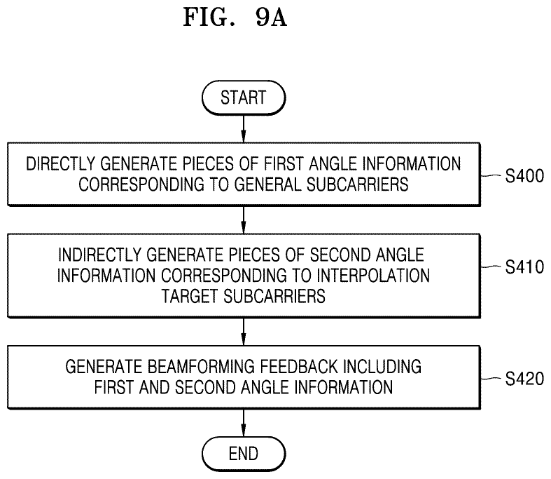

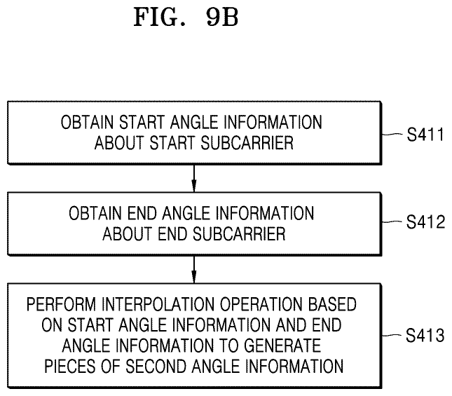

FIG. 9A is a flowchart for describing an operating method of a beamformee, according to an example embodiment, and FIG. 9B is a flowchart for describing operation S410 of FIG. 9A in detail.

Referring to FIG. 9A, at operation S400, the beamformee may directly generate pieces of first angle information corresponding to general subcarriers among a plurality of subcarriers.

At operation S410, the beamformee may indirectly generate pieces of second angle information corresponding to interpolation target subcarriers among the plurality of subcarriers.

At operation S420, the beamformee may generate beamforming feedback which includes the pieces of first angle information generated at operation S400 and the pieces of second angle information generated at operation S410.

Referring further to FIG. 9B, at operation S411, the beamformee may obtain start angle information about a start subcarrier, corresponding to the interpolation target subcarriers, from the pieces of first angle information which are generated at operation S400.

At operation S412, the beamformee may obtain end angle information about an end subcarrier, corresponding to the interpolation target subcarriers, from the pieces of first angle information which are generated at operation S400.

At operation S413, the beamformee may perform an interpolation operation to generate pieces of second angle information, based on the start angle information obtained at operation S411 and the end angle information obtained at operation S412.

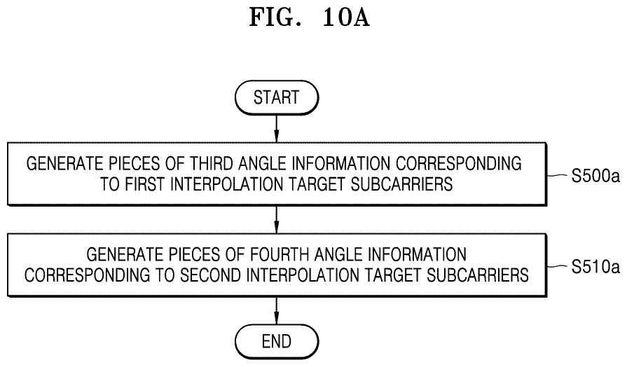

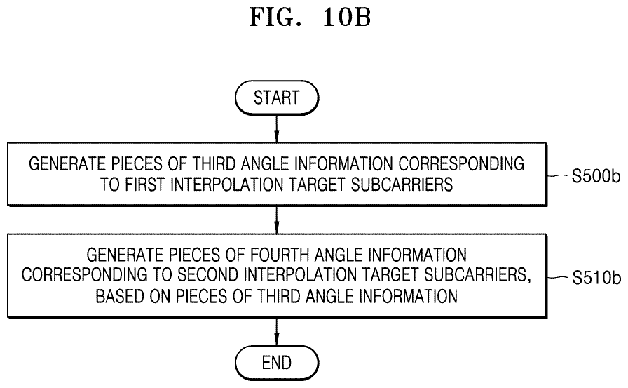

FIGS. 10A and 10B are flowcharts for describing an operating method of a beamformee, according to an example embodiment. FIGS. 10A and 10B will be described with reference to the embodiment of FIG. 8.

Referring to FIG. 10A, at operation S500a, the beamformee may generate pieces of third angle information corresponding to first interpolation target subcarriers.

At operation S510a, the beamformee may generate pieces of fourth angle information corresponding to second interpolation target subcarriers.

In an embodiment, the beamformee may independently perform each of operation S500a and operation S510a in sequence. In an embodiment, the beamformee may independently perform each of operation S500a and operation S510a in parallel.

Referring further to FIG. 10B, at operation S500b, the beamformee may generate the pieces of third angle information corresponding to the first interpolation target subcarriers.

At operation S510b, the beamformee may generate pieces of fourth angle information corresponding to the second interpolation target subcarriers, based on the pieces of third angle information generated at operation S500b.

In an embodiment, the beamformee may perform an operation of generating the pieces of fourth angle information in conjunction with an operation of generating the pieces of third angle information. For example, the beamformee may reflect the pieces of third angle information in the pieces of fourth angle information which are generated by interpolating pieces of angle information about a second start carrier and a second end subcarrier corresponding to the second interpolation target subcarriers, and thus, may adjust the pieces of fourth angle information. As an example, the beamformee may generate the pieces of fourth angle information by using the pieces of third angle information instead of the pieces of angle information about the second start carrier and the second end subcarrier corresponding to the second interpolation target subcarriers.

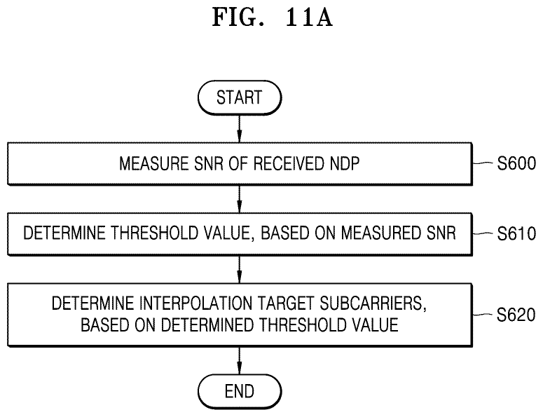

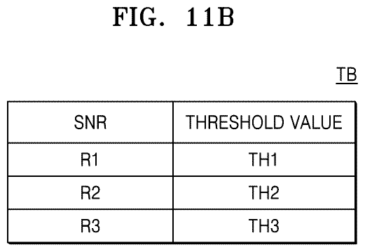

FIG. 11A is a flowchart for describing an operating method of a beamformee, according to an example embodiment, and FIG. 11B is a table diagram for describing an example embodiment associated with operation S610 of FIG. 11A.

Referring to FIG. 11A, at operation S600, the beamformee may measure a signal to noise ratio (SNR) of a received NDP.

At operation S610, the beamformee may determine a threshold value, based on the SNR which is measured at operation S600. For example, the beamformee according to an embodiment illustrated in FIG. 8 may determine a threshold value which is reduced as the measured SNR is lowered.

In some embodiments, in the beamformee, a plurality of threshold values may be previously defined, and one of a plurality of threshold values, based on the measured SNR. Referring further to FIG. 11B, a memory included in the beamformee may store a table TB, and in the table TB, a threshold value having a ‘TH1’ value may be selected when the measured SNR is within a first range R1, a threshold value having a ‘TH2’ value may be selected when the measured SNR is within a second range R2, and a threshold value having a ‘TH3’ value may be selected when the measured SNR is within a third range R3. For example, ‘TH1’, ‘TH2’, and ‘TH3’ may be listed in a magnitude order of threshold value when the first range R1, the second range R2, and the third range R3 are listed in a magnitude order of SNR.

That is, because it is difficult to accurately estimate a channel state between the beamformee and the beamformer due to noise as the measured SNR is reduced, the beamformee may limit a condition for determining interpolation target subcarriers, based on the measured SNR. As a detailed example, the beamformee may set a threshold value to have a very low value so that the interpolation target subcarriers are not determined when the measured SNR is very low.

At operation S620, the beamformee may determine the interpolation target subcarriers, based on the threshold value which is determined at operation S610.

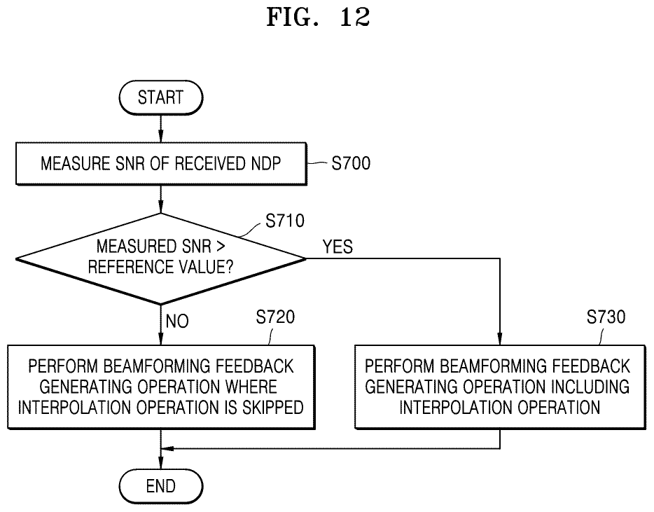

FIG. 12 is a flowchart for describing an operating method of a beamformee, according to an example embodiment.

Referring to FIG. 12, at operation S700, the beamformee may measure an SNR of a received NDP.

At operation S710, the beamformee may determine whether the SNR measured at operation S700 is greater than a reference value. For example, when the measured SNR is less than a reference value, because it is difficult to accurately estimate a channel state between the beamformee and the beamformer, the beamformee may not perform an interpolation operation according to the embodiments described above.

When operation S710 is ‘NO’, the beamformee may perform a beamforming feedback generating operation where an interpolation operation is skipped, at operation S720. For example, the beamformee may not determine interpolation target subcarriers and may directly generate pieces of angle information about all subcarriers.

When operation S710 is ‘YES’, the beamformee may perform a beamforming feedback generating operation including an interpolation operation at operation S730. For example, the beamformee may determine interpolation target subcarriers, perform an interpolation operation on the interpolation target subcarriers to generate pieces of angle information, and perform an interpolation operation on general subcarriers to directly generate pieces of angle information.

As described above, the beamformee may selectively perform an interpolation operation on interpolation target subcarriers to generate beamforming feedback, based on the measured SNR.

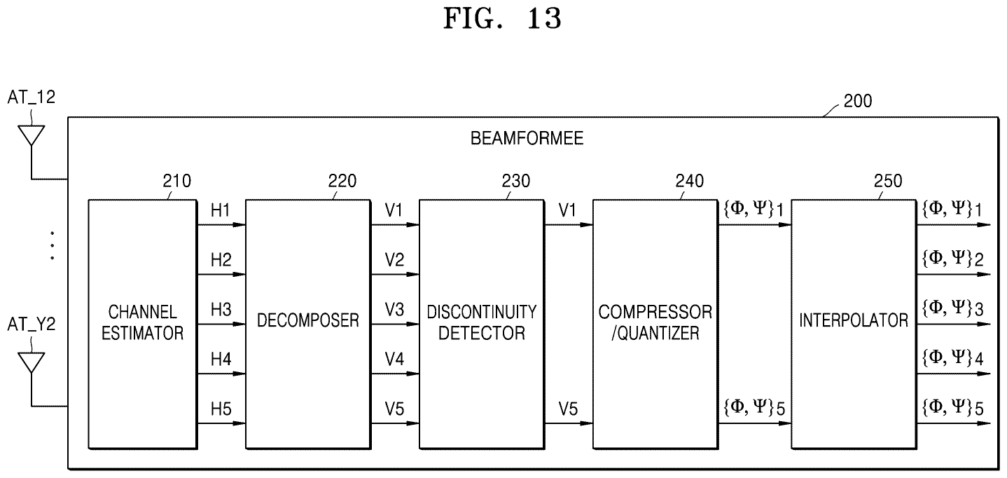

FIG. 13 is a detailed block diagram of a beamformee 200 according to an example embodiment.

Referring to FIG. 13, the beamformee 200 may include a plurality of second antennas AT_12 to AT_Y2, a channel estimator 210, a decomposer 220, a discontinuity detector 230, a compressor/quantizer 240, and an interpolator 250.

In an embodiment, the channel estimator 210 may estimate first to fifth channels H1 to H5 corresponding to a plurality of streams of each of first to fifth subcarriers and may provide the first to fifth channels H1 to H5 to the decomposer 220. In detail, the first channels H1 may include channels corresponding to the plurality of streams of the first subcarrier, the second channels H2 may include channels corresponding to the plurality of streams of the second subcarrier, the third channels H3 may include channels corresponding to the plurality of streams of the third subcarrier, the fourth channels H4 may include channels corresponding to the plurality of streams of the fourth subcarrier, and the fifth channels H5 may include channels corresponding to the plurality of streams of the fifth subcarrier.

In an embodiment, the decomposer 220 may decompose singular values of the first to fifth channels H1 to H5 to generate first to fifth beam steering matrixes V1 to V5 and may provide the first to fifth beam steering matrixes V1 to V5 to the discontinuity detector 230. In detail, the discontinuity detector 230 may perform, by stream units, a cross correlation between beam steering matrixes corresponding to an adjacent subcarrier on the first to fifth subcarriers and may determine interpolation target subcarriers, based on cross correlation values corresponding to the plurality of streams of each of the first to fifth subcarriers. For example, the discontinuity detector 230 may determine the second to fourth subcarriers as interpolation target subcarriers, and moreover, the discontinuity detector 230 may provide the compressor/quantizer 240 with only the first and fifth beam steering matrixes V1 and V5 of the first and fifth subcarriers which are general subcarriers. The first subcarrier may be referred to as a start subcarrier, and the fifth subcarrier may be referred to as an end subcarrier.

In an embodiment, the compressor/quantizer 240 may generate first angle information “{ϕ, ψ}1”, based on the first beam steering matrixes V1, and may generate fifth angle information “{ϕ, ψ}5”, based on the fifth beam steering matrixes V5, and may provide the first angle information “{ϕ, ψ}1” and the fifth angle information “{ϕ, ψ}5” to the interpolator 250.

In an embodiment, the interpolator 250 may perform an interpolation operation to generate second to fourth angle information “{ϕ, ψ}2”, “{ϕ, ψ}3”, and “{ϕ, ψ}4” corresponding to the second to fourth subcarriers, based on the first angle information “{ϕ, ψ}1” and the fifth angle information “{ϕ, ψ}5”.

Subsequently, the beamformee 200 may generate beamforming feedback including the first to fifth angle information “{ϕ, ψ}1” to “{ϕ, ψ}5” and may transmit the beamforming feedback to the beamformer.

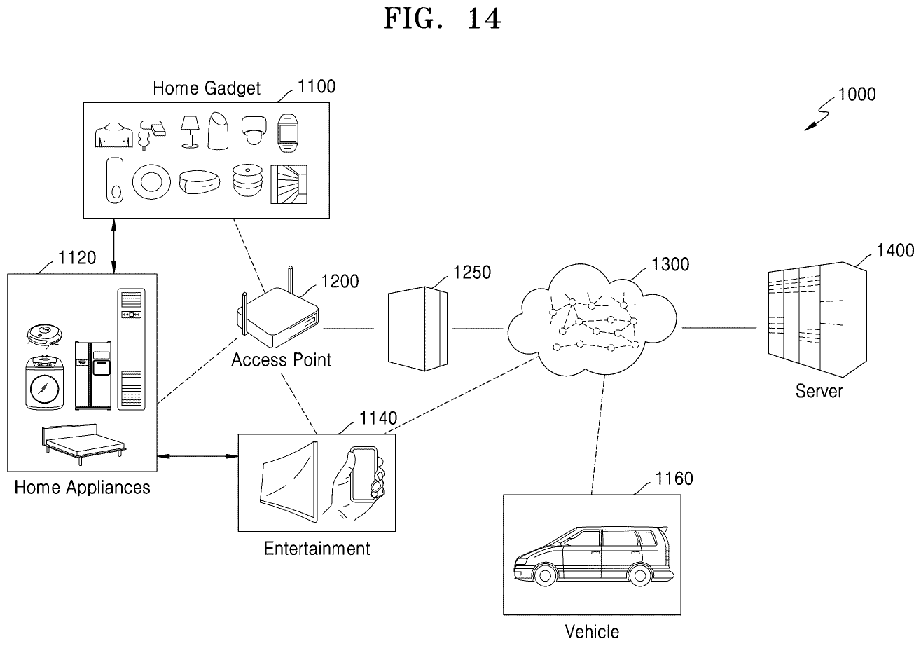

FIG. 14 is a concept diagram illustrating an Internet of things (IoT) network system 1000 to which embodiments are applied.

Referring to FIG. 14, the IoT network system 1000 may include a plurality of IoT devices 1100, 1120, 1140, and 1160, an access point 1200, a gateway 1250, a wireless network 1300, and a server 1400. IoT may denote an internet of things network using wired/wireless communication.

Each of the IoT devices 1100, 1120, 1140, and 1160 may configure a group, based on a characteristic of each IoT device. For example, the IoT devices 1100, 1120, 1140, and 1160 may be grouped into a home gadget group 1100, a home appliances/furniture group 1120, an entertainment group 1140, or a vehicle group 1160. The plurality of IoT devices 1100, 1120, 1140, and 1160 may be connected to a communication network or other IoT devices through the access point 1200. The access point 1200 may be embedded into one IoT device. The gateway 1250 may change protocol so that the access point 1200 accesses an external wireless network. The IoT devices 1100, 1120, and 1140 may be connected to an external communication network through the gateway 1250. The wireless network 1300 may include Internet and/or a public network. The plurality of IoT devices 1100, 1120, 1140, and 1160 may be connected to the server 1400 providing a certain service over the wireless network 1300, and a user may use a service through at least one of the plurality of IoT devices 1100, 1120, 1140, and 1160.

According to embodiments, the plurality of IoT devices 1100, 1120, 1140, and 1160 may determine the interpolation target subcarriers described above and may generate pieces of angle information corresponding to the interpolation target subcarriers through an interpolation operation, thereby maximizing an effect of smooth beamforming. As a result, the plurality of IoT devices 1100, 1120, 1140, and 1160 may perform efficient and effective communication to provide a good-quality service to a user.

Hereinabove, exemplary embodiments have been described in the drawings and the specification. Embodiments have been described by using the terms described herein, but this has been merely used for describing the inventive concept and has not been used for limiting a meaning or limiting the scope of the inventive concept defined in the following claims. Therefore, it may be understood by those of ordinary skill in the art that various modifications and other equivalent embodiments may be implemented from the inventive concept. Accordingly, the spirit and scope of the inventive concept may be defined based on the spirit and scope of the following claims.

While the inventive concept has been particularly shown and described with reference to embodiments thereof, it will be understood that various changes in form and details may be made therein without departing from the spirit and scope of the following claims.

What is claimed is:

1. An operating method of a first apparatus communicating with a second apparatus in a wireless local area network (WLAN) system including the first apparatus and the second apparatus, the operating method comprising:
receiving a null data packet (NDP) from the second apparatus;
estimating channels corresponding to a plurality of streams of each of a plurality of subcarriers by using the NDP;
decomposing singular values of the estimated channels to generate beam steering matrixes corresponding to the plurality of streams of each of the plurality of subcarriers;
performing, by stream units, cross correlation between beam steering matrixes corresponding to an adjacent subcarrier of the plurality of subcarriers;
determining interpolation target subcarriers, based on cross correlation values corresponding to the plurality of streams of each of the plurality of subcarriers; and
generating beamforming feedback, based on the determined interpolation target subcarriers.

2. The operating method of claim 1,
wherein the plurality of subcarriers comprises a first subcarrier,
wherein the cross correlation values comprise first cross correlation values corresponding to the plurality of streams of the first subcarrier, and
wherein the determining of the interpolation target subcarriers comprises:
comparing a threshold value with a first minimum value of the first cross correlation values; and
determining the interpolation target subcarriers with respect to the first subcarrier, based on a result of the comparison.

3. The operating method of claim 1,
wherein the plurality of subcarriers comprises a first subcarrier and a second subcarrier having an index of lower priority than the first subcarrier,
wherein the cross correlation values comprise first cross correlation values corresponding to the plurality of streams of the first subcarrier, and second cross correlation values corresponding to the plurality of streams of the second subcarrier, and
wherein the determining of the interpolation target subcarriers comprises:
checking that a first minimum value of the first cross correlation values is less than a threshold value, to determine the first subcarrier as a start subcarrier;
checking that a second minimum value of the second cross correlation values is greater than or equal to the threshold value, to determine the second subcarrier as an end subcarrier; and
determining, as the interpolation target subcarriers, subcarriers between the start subcarrier and the end subcarrier with respect to the index.

4. The operating method of claim 1, wherein the determining of the interpolation target subcarriers comprises:
measuring a signal-to-noise ratio (SNR) of the NDP;
determining a threshold value, based on the measured SNR; and
comparing the cross correlation values with the determined threshold value to determine the interpolation target subcarriers.

5. The operating method of claim 1, further comprising:
measuring a signal-to-noise ratio (SNR) of the NDP,
wherein the determining of the interpolation target subcarriers is performed under a condition in which the measured SNR is greater than or equal to a reference value.

6. The operating method of claim 1, wherein the generating of the beamforming feedback comprises:
generating, from the beam steering matrixes, start angle information about a start subcarrier and end angle information about an end subcarrier, corresponding to each of the determined interpolation target subcarriers; and
performing an interpolation operation, based on the start angle information and the end angle information, to generate pieces of angle information corresponding to the determined interpolation target subcarriers.

7. The operating method of claim 1, wherein the determined interpolation target subcarriers comprise a first group including first interpolation target subcarriers and a second group including second interpolation target subcarriers, the first group and the second group being apart from each other based on an index.

8. The operating method of claim 7, wherein the generating of the beamforming feedback comprises:
independently generating, from the beam steering matrixes, pieces of angle information corresponding to the first interpolation target subcarriers, and pieces of angle information corresponding to the second interpolation target subcarriers.

9. The operating method of claim 7, wherein the generating of the beamforming feedback comprises:
generating, from the beam steering matrixes, pieces of angle information corresponding to the first interpolation target subcarriers, and pieces of angle information corresponding to the second interpolation target subcarriers, in conjunction with each other.

10. The operating method of claim 1, further comprising:
transmitting the beamforming feedback to the second apparatus;
receiving a smooth beamformed physical protocol data unit (PPDU) from the second apparatus, based on the beamforming feedback; and
performing channel smoothing on the smooth beamformed PPDU.

11. The operating method of claim 1, wherein communication between the first apparatus and the second apparatus is based on an extremely high throughput (EHT) protocol standard.

12. A first apparatus communicating with a second apparatus in a wireless local area network (WLAN) system, the first apparatus comprising:
a channel estimator configured to estimate channels corresponding to a plurality of streams of each of a plurality of subcarriers by using a null data packet (NDP) received from the second apparatus;
a discontinuity detector configured to perform, by stream units, cross correlation between beam steering matrixes corresponding to an adjacent subcarrier of the plurality of subcarriers by using the estimated channels, to determine interpolation target subcarriers of which a representative cross correlation value is less than a threshold value and which are sequentially listed with respect to an index; and
an interpolator configured to perform an interpolation operation to generate pieces of angle information corresponding to the determined interpolation target subcarriers.

13. The first apparatus of claim 12,
wherein the plurality of subcarriers comprises a first subcarrier, and
wherein the discontinuity detector is configured to compare the threshold value with a minimum value of first cross correlation values corresponding to the plurality of streams of the first subcarrier, as a first representative cross correlation value of the first subcarrier.

14. The first apparatus of claim 12,
wherein the plurality of subcarriers comprises a first subcarrier and a second subcarrier having an index of lower priority than the first subcarrier, and
wherein the discontinuity detector is configured to check that a first representative cross correlation value of the first subcarrier is less than the threshold value to determine the first subcarrier as a start subcarrier, check that a second representative cross correlation value of the second subcarrier is greater than or equal to the threshold value to determine the second subcarrier as an end subcarrier, and determine, as the interpolation target subcarriers, subcarriers between the start subcarrier and the end subcarrier with respect to an index.

15. The first apparatus of claim 12, wherein the threshold value is based on a signal- to-noise ratio (SNR) measured by using the NDP.

16. The first apparatus of claim 15, wherein the smaller the measured SNR, the smaller the threshold value.

17. The first apparatus of claim 15, wherein the discontinuity detector is configured to determine the interpolation target subcarriers under a condition in which the SNR measured by using the NDP is greater than or equal to a reference value.

18. The first apparatus of claim 12, wherein the interpolator is configured to perform the interpolation operation, based on start angle information in regard to a start subcarrier and end angle information in regard to an end subcarrier, corresponding to the interpolation target subcarriers.

19. The first apparatus of claim 12, further comprising a transceiver configured to transmit beamforming feedback, including the pieces of angle information, to the second apparatus.

20. An operating method of a first apparatus communicating with a second apparatus in a wireless local area network (WLAN) system including the first apparatus and the second apparatus, the operating method comprising:
receiving a null data packet (NDP) from the second apparatus;
estimating channels corresponding to a plurality of streams of each of a plurality of subcarriers by using the NDP;
performing, by stream units, a cross correlation between beam steering matrixes of adjacent subcarriers of the plurality of subcarriers by using the estimated channels;
determining interpolation target subcarriers, of which a representative cross correlation value is less than a threshold value and which are sequentially listed with respect to an index, of the plurality of subcarriers;
performing an interpolation operation to generate pieces of angle information in regard to the determined interpolation target subcarriers; and
transmitting beamforming feedback, including the generated pieces of angle information, to the second apparatus.
